(19) United States
(12) Patent Application Publication
(10) Pub. No.: US 2026/0065512 A1
(43) Pub. Date: Mar. 5, 2026

(54) FAST BOUNDING VOLUME HIERARCHY TREE REBUILD FOR DYNAMIC GEOMETRIES USING NEURAL NETWORKS

(71) Applicant: Advanced Micro Devices, Inc., Santa Clara, CA (US)

(72) Inventors: Binh Huy Le, Santa Clara, CA (US); Yang Shen, Boxborough, MA (US); Madhusudhanan Srinivasan, Austin, TX (US); Mark Richard Nutter, Austin, TX (US); Aaron Michael Knoll, Santa Clara, CA (US)

(73) Assignee: Advanced Micro Devices, Inc., Santa Clara, CA (US)

(21) Appl. No.: 18/821,034

(22) Filed: Aug. 30, 2024

(51) Int. Cl. G06T 9/00; G06T 9/40; G06T 13/20; G06T 15/06

(52) U.S. Cl. CPC G06T 9/002; G06T 9/001; G06T 9/40; G06T 13/20; G06T 15/06; G06T 2210/21

(57) ABSTRACT

Techniques herein involve building bounding volume hierarchies for ray tracing using neural networks. These techniques use one trained neural network per animated mesh, with each such neural network being trained for a particular mesh topology. Meshes can be animated or otherwise modified to represent a single geometry object or portion of a geometry object in various animation states. Training a single neural network for each animated mesh allows such a neural network to generate BVHs for any animation state for the corresponding animated mesh in a robust manner. In other words, by limiting the responsibility of each such trained neural network to a single mesh topology (and therefore providing constraints to what the trained neural network must learn), it is possible for such a trained neural network to robustly and accurately generate BVHs.

### BACKGROUND

In image synthesis, ray tracing is utilized to find a nearest intersection of a given ray with a scene where light propagation is simulated.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail, according to an example;

FIG. 3 illustrates a ray tracing pipeline for rendering graphics using a ray tracing technique, according to an example;

FIG. 4 is an illustration of a bounding volume hierarchy (“BVH”), according to an example;

FIG. 5 illustrates operations for training neural network models to generate BVHs based on input meshes.

FIG. 6 illustrates example mesh and BVH encodings;

FIG. 7 illustrates an example for obtaining a BVH from a trained neural network model based on a mesh encoding; and

FIGS. 8A and 8B are flow diagrams of methods for performing training and inference for obtaining BVHs based on input meshes.

### DETAILED DESCRIPTION

Ray tracing is a rendering technique whereby rays are cast into a scene and pixels of a render target are colored based on which objects the rays intersect. To speed such operations up, a ray tracing system typically builds an acceleration structure such as a bounding volume hierarchy (“BVH”). Such a structure has a hierarchy of levels, where each level can include bounding volumes that bound the geometry of lower levels.

Building a BVH is an expensive process, usually requiring consideration of multiple alternatives per branching path and complex calculations. Techniques are thus provided herein for using trained neural networks to generate BVHs from meshes. These techniques use one trained neural network per mesh topology, each such neural network being trained for that corresponding mesh topology. A “mesh topology” means a set of vertices, with positions unspecified, but with connectivity between the vertices to form triangles specified. Together with vertex positions, a mesh topology specifies a mesh, including both vertex positions and vertex connectivity. Techniques disclosed herein are beneficial for animated meshes.

At application execution time, meshes can be animated or otherwise modified to represent a single geometry object or portion of a geometry object in various states of deformation (also called “animation states”). Each animation state for a given mesh has the same topology—number of vertices and the same connectivity between vertices, but the positions of those vertices can vary. In other words, animating a mesh comprises modifying the vertex positions of a mesh. Training a single neural network for each mesh topology allows such a neural network to generate BVHs for any animation state for the corresponding mesh topology in a robust manner. In other words, by limiting the responsibility of each such trained neural network to a single mesh topology (and therefore providing constraints to what the trained neural network must learn), it is possible for such a trained neural network to robustly and accurately generate BVHs. Further, by providing one such trained network per animated mesh in a scene to be rendered, it is possible to generate BVHs for multiple objects in a scene.

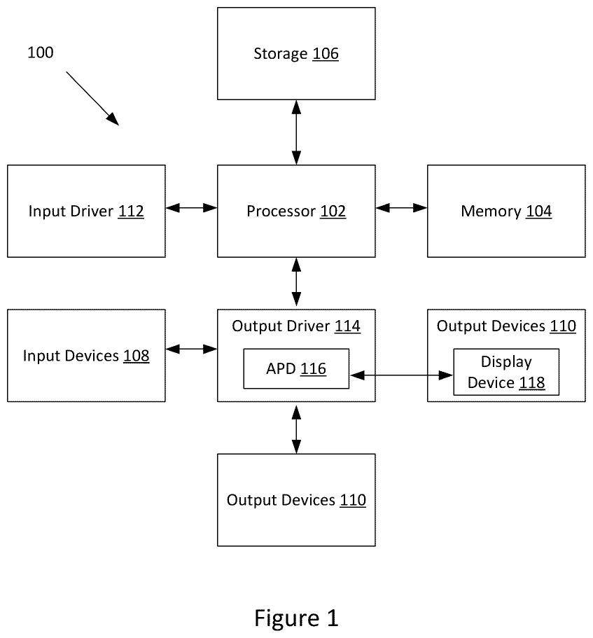

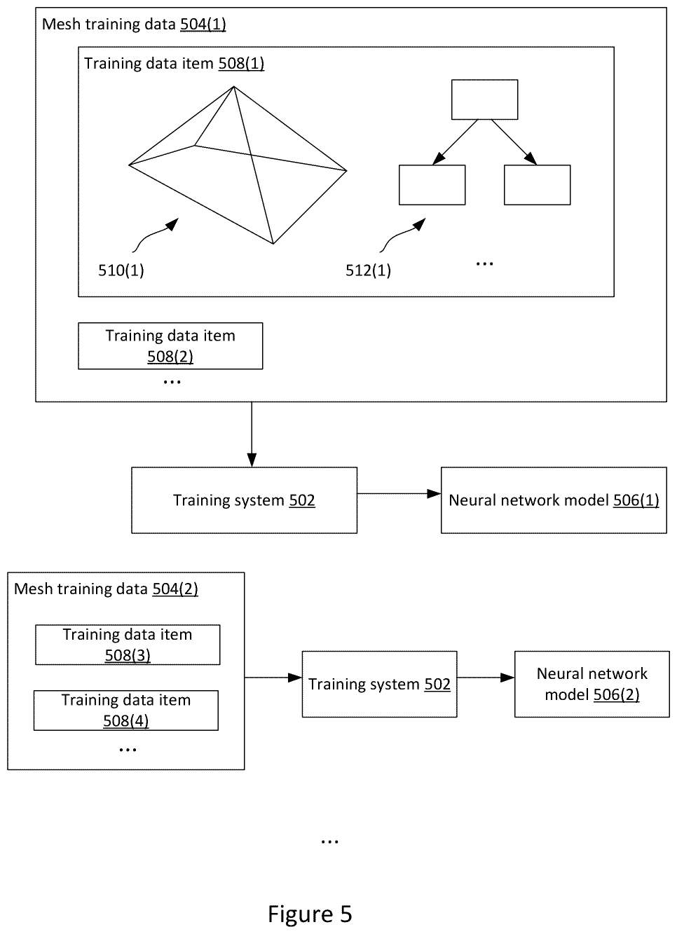

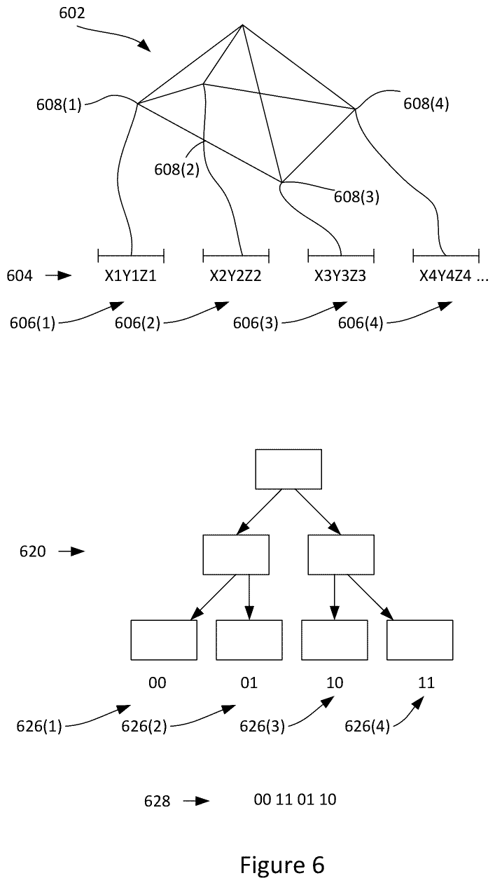

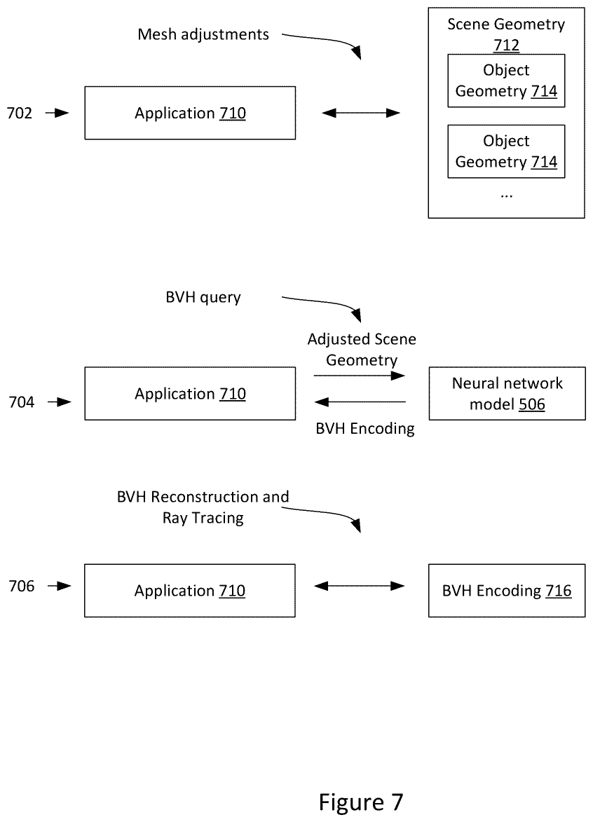

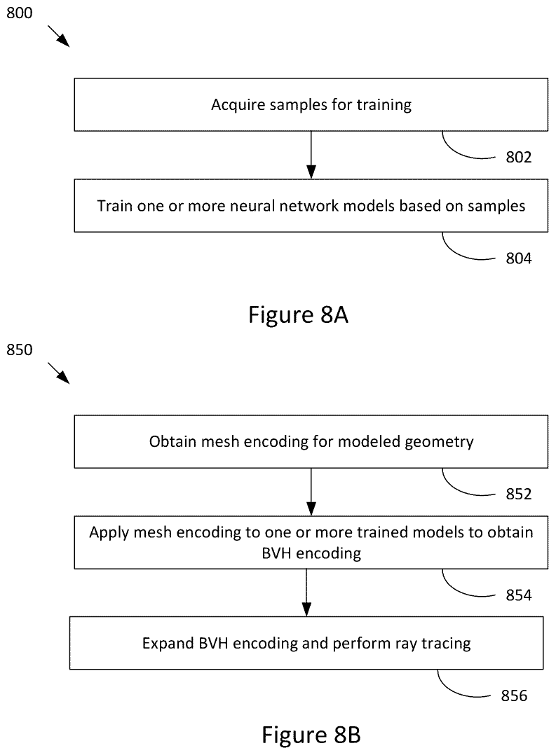

In the present disclosure, FIGS. 1-4 provide background for ray tracing. FIG. 5 illustrates operations for training a neural network model to generate BVHs for animated meshes. FIG. 6 illustrates example encodings for the inputs and outputs to the trained neural network models. FIG. 7 illustrates operations for obtaining a BVH in response to an animation state. FIGS. 8A and 8B illustrate methods for training and inference for generating BVHs from animation states.

FIG. 1 is a block diagram of an example device 100 in which one or more features of the disclosure can be implemented. The device 100 can include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 114 includes an accelerated processing device (“APD”) 116 which is coupled to a display device 118. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm performs the functionality described herein.

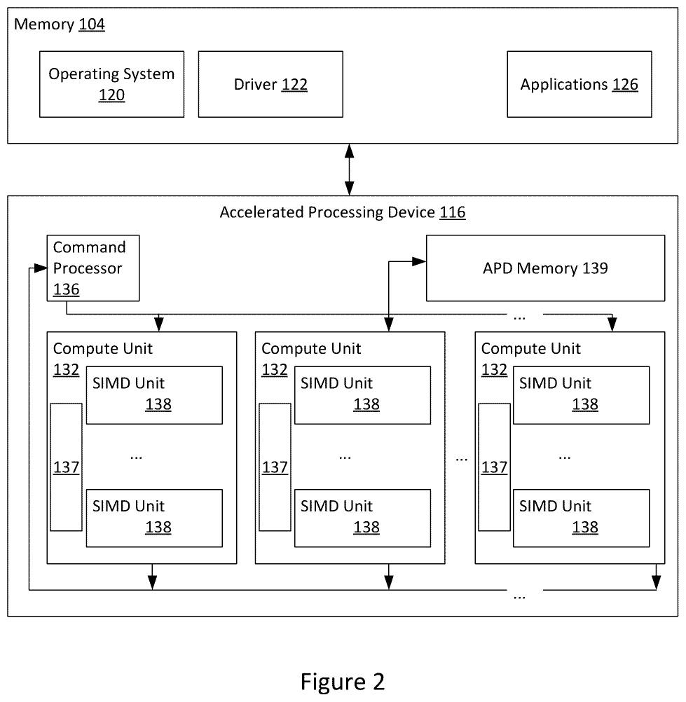

FIG. 2 is a block diagram of the device 100, illustrating additional details related to execution of processing tasks on the APD 116, according to an example. The processor 102 maintains, in system memory 104, one or more control logic modules for execution by the processor 102. The control logic modules include an operating system 120, a driver 122, and applications 126. These control logic modules control various features of the operation of the processor 102 and the APD 116. For example, the operating system 120 directly communicates with hardware and provides an interface to the hardware for other software executing on the processor 102. The driver 122 controls operation of the APD 116 by, for example, providing an application programming interface (“API”) to software (e.g., applications 126) executing on the processor 102 to access various functionality of the APD 116. The driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that perform operations at the request of the processor 102 in a parallel manner according to a SIMD paradigm. Each compute unit 132 includes a local data share (“LDS”) 137 that is accessible to wavefronts executing in the compute unit 132 but not to wavefronts executing in other compute units 132. A global memory 139 stores data that is accessible to wavefronts executing on all compute units 132. In some examples, the local data share 137 has faster access characteristics than the global memory 139 (e.g., lower latency and/or higher bandwidth). Although shown in the APD 116, the global memory 139 can be partially or fully located in other elements, such as in system memory 104 or in another memory not shown or described. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 performs operations related to scheduling various wavefronts on different compute units 132 and SIMD units 138.

The parallelism afforded by the compute units 132 is suitable for graphics related operations such as pixel value calculations, vertex transformations, and other graphics operations. Thus in some instances, a graphics pipeline, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline (e.g., custom operations performed to supplement processing performed for operation of the graphics pipeline). An application 126 or other software executing on the processor 102 transmits programs that define such computation tasks to the APD 116 for execution.

The APD 116 is configured to implement features of the present disclosure by executing a plurality of functions as described in more detail below. For example, the APD 116 is configured to receive images comprising one or more three dimensional (3D) objects, divide images into a plurality of tiles, execute a visibility pass for primitives of an image, divide the image into tiles, execute coarse level tiling for the tiles of the image, divide the tiles into fine tiles and execute fine level tiling of the image. Optionally, the front end geometry processing of a primitive determined to be in a first one of the tiles can be executed concurrently with the visibility pass.

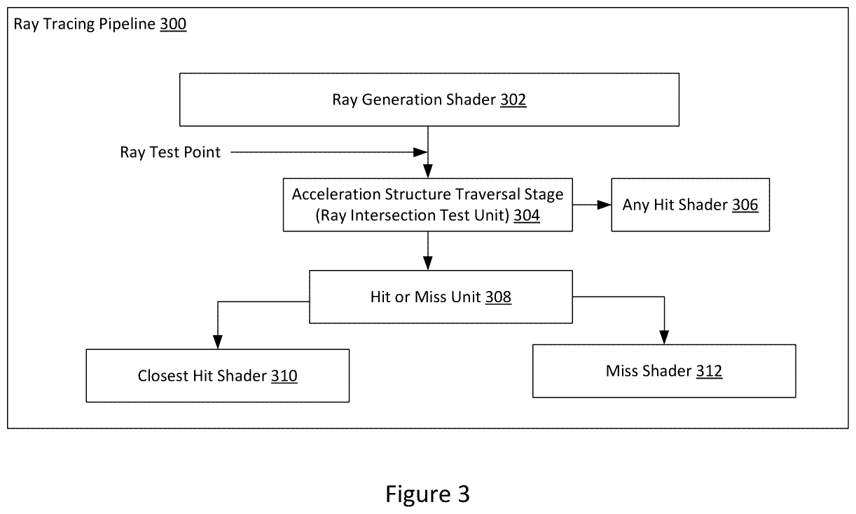

FIG. 3 illustrates a ray tracing pipeline 300 for rendering graphics using a ray tracing technique, according to an example. The ray tracing pipeline 300 provides an overview of operations and entities involved in rendering a scene utilizing ray tracing. A ray generation shader 302, any hit shader 306, closest hit shader 310, and miss shader 312 are shader-implemented stages that represent ray tracing pipeline stages whose functionality is performed by shader programs executing in the SIMD unit 138. Any of the specific shader programs at each particular shader-implemented stage are defined by application-provided code (i.e., by code provided by an application developer that is pre-compiled by an application compiler and/or compiled by the driver 122). The acceleration structure traversal stage 304 performs a ray intersection test to determine whether a ray hits a triangle.

The various programmable shader stages (ray generation shader 302, any hit shader 306, closest hit shader 310, miss shader 312) are implemented as shader programs that execute on the SIMD units 138. The acceleration structure traversal stage 304 is implemented in software (e.g., as a shader program executing on the SIMD units 138), in hardware, or as a combination of hardware and software. The hit or miss unit 308 is implemented in any technically feasible manner, such as as part of any of the other units, implemented as a hardware accelerated structure, or implemented as a shader program executing on the SIMD units 138. The ray tracing pipeline 300 may be orchestrated partially or fully in software or partially or fully in hardware, and may be orchestrated by the processor 102, the scheduler 136, by a combination thereof, or partially or fully by any other hardware and/or software unit. The term “ray tracing pipeline processor” used herein refers to a processor executing software to perform the operations of the ray tracing pipeline 300, hardware circuitry hard-wired to perform the operations of the ray tracing pipeline 300, or a combination of hardware and software that together perform the operations of the ray tracing pipeline 300.

The ray tracing pipeline 300 operates in the following manner. A ray generation shader 302 is executed. The ray generation shader 302 sets up data for a ray to test against a triangle and requests the acceleration structure traversal stage 304 test the ray for intersection with triangles.

The acceleration structure traversal stage 304 traverses an acceleration structure, which is a data structure that describes a scene volume and objects (such as triangles) within the scene, and tests the ray against triangles in the scene. In various examples, the acceleration structure is a bounding volume hierarchy. The hit or miss unit 308, which, in some implementations, is part of the acceleration structure traversal stage 304, determines whether the results of the acceleration structure traversal stage 304 (which may include raw data such as barycentric coordinates and a potential time to hit) actually indicates a hit. For triangles that are hit, the ray tracing pipeline 300 triggers execution of an any hit shader 306. Note that multiple triangles can be hit by a single ray. It is not guaranteed that the acceleration structure traversal stage will traverse the acceleration structure in the order from closest-to-ray-origin to farthest-from-ray-origin. The hit or miss unit 308 triggers execution of a closest hit shader 310 for the triangle closest to the origin of the ray that the ray hits, or, if no triangles were hit, triggers a miss shader.

Note, it is possible for the any hit shader 306 to “reject” a hit from the ray intersection test unit 304, and thus the hit or miss unit 308 triggers execution of the miss shader 312 if no hits are found or accepted by the ray intersection test unit 304. An example circumstance in which an any hit shader 306 may “reject” a hit is when at least a portion of a triangle that the ray intersection test unit 304 reports as being hit is fully transparent. Because the ray intersection test unit 304 only tests geometry, and not transparency, the any hit shader 306 that is invoked due to a hit on a triangle having at least some transparency may determine that the reported hit is actually not a hit due to “hitting” on a transparent portion of the triangle. A typical use for the closest hit shader 310 is to color a material based on a texture for the material. A typical use for the miss shader 312 is to color a pixel with a color set by a skybox. It should be understood that the shader programs defined for the closest hit shader 310 and miss shader 312 may implement a wide variety of techniques for coloring pixels and/or performing other operations.

A typical way in which ray generation shaders 302 generate rays is with a technique referred to as backwards ray tracing. In backwards ray tracing, the ray generation shader 302 generates a ray having an origin at the point of the camera. The point at which the ray intersects a plane defined to correspond to the screen defines the pixel on the screen whose color the ray is being used to determine. If the ray hits an object, that pixel is colored based on the closest hit shader 310. If the ray does not hit an object, the pixel is colored based on the miss shader 312. Multiple rays may be cast per pixel, with the final color of the pixel being determined by some combination of the colors determined for each of the rays of the pixel. As described elsewhere herein, it is possible for individual rays to generate multiple samples, which each sample indicating whether the ray hits a triangle or does not hit a triangle. In an example, a ray is cast with four samples. Two such samples hit a triangle and two do not. The triangle color thus contributes only partially (for example, 50%) to the final color of the pixel, with the other portion of the color being determined based on the triangles hit by the other samples, or, if no triangles are hit, then by a miss shader.

It is possible for any of the any hit shader 306, closest hit shader 310, and miss shader 312, to spawn their own rays, which enter the ray tracing pipeline 300 at the ray test point. These rays can be used for any purpose. One common use is to implement environmental lighting or reflections. In an example, when a closest hit shader 310 is invoked, the closest hit shader 310 spawns rays in various directions. For each object, or a light, hit by the spawned rays, the closest hit shader 310 adds the lighting intensity and color to the pixel corresponding to the closest hit shader 310. It should be understood that although some examples of ways in which the various components of the ray tracing pipeline 300 can be used to render a scene have been described, any of a wide variety of techniques may alternatively be used.

As described above, the determination of whether a ray hits an object is referred to herein as a “ray intersection test. ” The ray intersection test involves shooting a ray from an origin and determining whether the ray hits a triangle and, if so, what distance from the origin the triangle hit is at. For efficiency, the ray tracing test uses a representation of space referred to as a bounding volume hierarchy. This bounding volume hierarchy is the “acceleration structure” described above. In a bounding volume hierarchy, each non-leaf node represents an axis aligned bounding box that bounds the geometry of all children of that node. In an example, the base node represents the maximal extents of an entire region for which the ray intersection test is being performed. In this example, the base node has two children that each represent mutually exclusive axis aligned bounding boxes that subdivide the entire region. Each of those two children has two child nodes that represent axis aligned bounding boxes that subdivide the space of their parents, and so on. Leaf nodes represent a triangle against which a ray test can be performed. It should be understood that where a first node points to a second node, the first node is considered to be the parent of the second node.

The bounding volume hierarchy data structure allows the number of ray-triangle intersections (which are complex and thus expensive in terms of processing resources) to be reduced as compared with a scenario in which no such data structure were used and therefore all triangles in a scene would have to be tested against the ray. Specifically, if a ray does not intersect a particular bounding box, and that bounding box bounds a large number of triangles, then all triangles in that box can be eliminated from the test. Thus, a ray intersection test is performed as a sequence of tests of the ray against axis-aligned bounding boxes, followed by tests against triangles.

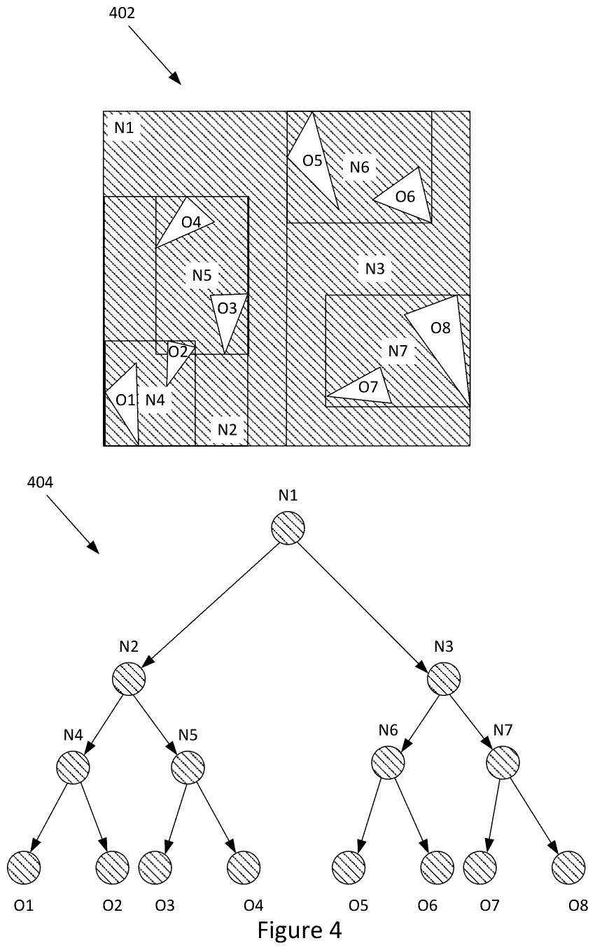

FIG. 4 is an illustration of a bounding volume hierarchy, according to an example. For simplicity, the hierarchy is shown in 2D. However, extension to 3D is simple, and it should be understood that the tests described herein would generally be performed in three dimensions.

The spatial representation 402 of the bounding volume hierarchy is illustrated in the left side of FIG. 4 and the tree representation 404 of the bounding volume hierarchy is illustrated in the right side of FIG. 4. The non-leaf nodes are represented with the letter “N” and the leaf nodes are represented with the letter “O” in both the spatial representation 402 and the tree representation 404. A ray intersection test would be performed by traversing through the tree 404, and, for each non-leaf node tested, eliminating branches below that node if the box test for that non-leaf node fails. For leaf nodes that are not eliminated, a ray-triangle intersection test is performed to determine whether the ray intersects the triangle at that leaf node.

In an example, the ray intersects O₅ but no other triangle. The test would test against N₁, determining that that test succeeds. The test would test against N₂, determining that the test fails (since O₅ is not within N₁). The test would eliminate all sub-nodes of N₂ and would test against N₃, noting that that test succeeds. The test would test N₆ and N₇, noting that N₆ succeeds but N₇ fails. The test would test O₅ and O₆, noting that O₅ succeeds but O₆ fails. Instead of testing 8 triangle tests, two triangle tests (O₅ and O₆) and five box tests (N₁, N₂, N₃, N₆, and N₇) are performed.

As just stated, in order to perform ray tracing operations, the ray tracing pipeline 300 uses one or more bounding volume hierarchies (“BVHs”) that act as an acceleration structure for accessing the geometry of a scene. In applications such as video games, simulations, or other real-time applications, geometry of the scene changes frequently such as at every frame. Thus, to have appropriate information for ray tracing, the ray tracing pipeline 300 or other entity such as the driver 122 or an application 126 must build a BVH quite frequently. Such an operation is an expensive one. Thus, efficient techniques for BVH construction are desirable.

The present disclosure provides techniques for building BVHs using machine learning. Specifically, the techniques utilize a training mechanism to train neural network-based models for geometric models offline (e.g., not at runtime, such as during asset creation time), and utilize such trained neural-network models to build a BVH for the corresponding geometry models at runtime. More specifically, each trained neural network model corresponds to a single geometric model of a scene (where such “geometric model” is also sometimes herein referred to as a “single mesh” or a “mesh topology”). Each such trained neural network model is trained to output a bounding volume hierarchy for a given set of vertex positions corresponding to the geometric model. The set of vertex positions defines an animation state for the geometric model. The trained neural network for that model provides, as output, the BVH, given that animation state. Put differently, each geometric model is associated with a trained neural network model which defines how to build a BVH given the animation state of that model, where the “animation state” is defined by the positions of the vertices of the geometric model. For any given scene, there may be any number of such trained neural network models, each corresponding to a different geometric model of the scene. A BVH build would thus consist at least partially of providing the vertex information for a plurality of geometric models of a scene to corresponding trained neural network models and obtaining a BVH for each such geometric model as output.

In some examples, the overall BVH for a scene is represented as a two-level BVH that includes a top-level BVH and one or more bottom-level BVHs. The top-level BVH includes non-leaf nodes as well as one or more instance nodes. Each instance node includes an instance transform and a pointer to a bottom-level BVH. Each bottom-level BVH is a set of geometry that can be “reused” one or more times in the overall BVH. For example, it is possible for multiple difference instance nodes in the top-level BVH to point to the same bottom-level BVH, in which case, multiple copies of the geometry represented by that bottom-level BVH would appear in the scene. In addition, the instance nodes can have instance transforms that specify changes to position, scale, or orientation that therefore allow modified copies of such geometry to appear in the scene. In some examples, each trained neural network model is associated with a particular bottom-level BVH or a particular instance node, such that each trained neural network model is capable of providing a BVH for its corresponding bottom-level BVH or instance node. As a result, each trained neural network model is capable of generating a BVH for a particular bottom-level BVH. It should be understood that although use in the context of a two-level BVH is described, the techniques described herein are about building a BVH for an animated mesh and are not limited to use in a two-level BVH.

FIG. 5 illustrates a system for training neural network models for corresponding meshes, according to an example. As shown, a training system 502 accepts as input mesh training data 504 corresponding to a geometric model (or “mesh”) and trains a neural network model 506. In some examples, the training system 502 is an application executing on a device. In some examples, the training system 502 is one of the applications 126. In some examples, the training system 502 executes partially or fully on the APD 116, such as partially or fully as shader programs executing in the compute units 132. In some examples, the training system 502 is partially or fully implemented in hardware, such as fixed-function circuitry, digital circuitry, partially in digital circuitry and partially in analog circuitry, or in any other technically feasible manner.

Each mesh training data 504 is associated with an object, defined by a mesh topology. The mesh topology indicates a connectivity for a set of vertices. The mesh topology associated with a particular mesh training data 504 does not have vertex positions specified. Specifically, the mesh training data 504 includes a plurality of training data items 508. Each of those training data items 508 is associated with the same mesh topology but has different vertex positions. In some examples, the mesh training data 504 includes one copy of the mesh topology that defines the vertex connectivity, as well as multiple training data items 508, each of which specifies vertex positions. In some examples, each training data item 508 includes positions for the same number of vertices as each other training data item 508 of the same mesh training data 504.

The different training data items 508 represent different animation states (sometimes referred to as a “deformation state”) for a particular mesh. The training involves training the neural network model 506 to output a BVH, given a particular mesh. The mesh specifies the vertex positions of a particular animation state. Thus, the training involves training the neural network model 506 to generate a BVH for a given animation state.

As can be seen in FIG. 5, each mesh training data 504 produces a neural network model 506 for a particular mesh. Providing an input during inference, including a specific deformation or animation state for a particular mesh, to such a trained neural network model 506, thus results in an output BVH for that mesh, to be used for ray tracing operations. Put differently, the training generates a neural network model 506 corresponding to a mesh, where the neural network model 506 is capable of generating a BVH, given information specifying vertex positions.

The training system 502 and specific architecture of the neural network model 506 consists of any technically feasible choice. In one example, the neural network model 506 is a multi-layer perceptron trained via back-propagation which adjusts weights of the neurons of the multi-layer perceptron model to minimize error during training. In some examples, the error is based on the difference between an output BVH and the actual BVH present in the training data. In other examples, the neural network model 506 is based on a mesh convolutional neural network (“mesh CNN”), in which convolutional filters are applied to per-edge data sets. In an example of mesh convolution, at the finest layer, each edge is represented as a set of edge par (e.g., parameters defined by length of the edge, angle between neighboring edges, angle between faces, and/or other parameters). A filter is applied to this set of features, and the neural network system learns the weight values for such filters through back propagation, using training data input, where the error is defined based on the input training data (e.g., the BVH's 512) and the BVH produces as the output. A mesh CNN can include multiple layers, where subsequent layers collapse the edges of previous layers and apply and refine filters for such “coarser” geometry. The result of training a mesh CNN is that an input mesh can generate a desired output, such as, in this case, a BVH. In some examples, error for any technically feasible machine learning architecture can be defined based on a difference between a BVH encoding 628 (FIG. 6) generated for an input BVH and a BVH encoding output by the trained neural network model. In some examples, the difference is defined as the total number of elements that differ (e.g., the Hamming distance), though any technically feasible difference that characterizes the degree of difference between such encodings can be used. In other examples, the neural network predicts the split planes for the BVH build instead of directly predicting the BVH. In this case, the error is based on the difference of the BVH split planes in the training data and output split planes.

In an example, training for any given geometry model consists of a number of training iterations. In each training iteration, the training system 502 provides training data items 508 as described above, and the training system 502 adjusts the weights of the neural network model to more accurately produce the output BVH (e.g., to minimize the error).

FIG. 6 illustrates example input (“mesh”) and output (“BVH”) encodings for the input mesh and output BVH, according to an example. Although this is provided as an example, these examples should not be understood to be limiting, and other encodings are possible for the input and/or output data.

In an example, an example mesh 602 is encoded as a sequence of vertex position information. In the example illustrated, the encoding 604 of the mesh 602 is represented as a sequence of vertex encodings 606. Each vertex encoding 606 includes position information for a corresponding vertex 608 for each of three axes. The mesh encoding 604 thus includes a sequence of vertex encodings 606 for each vertex of the mesh.

It should be understood that, in some examples, a BVH places triangles (and not vertices) into a tree structure. Each triangle is associated with three vertices. As described elsewhere, each trained neural network model 506 is associated with a “fixed topology,” meaning that for any given trained neural network model 506, during inference (obtaining a BVH based on mesh vertex positions as input), the connectivity of the vertices remains the same regardless of what input is provided. The inference operation obtains and provides the vertex positions, and not the connectivity. This means that there is an at least implicit correspondence between the vertex encodings 606 and the leaf nodes of the BVH. In other words, each “slot” or position in the ordering of the mesh encoding sequence corresponds to a particular vertex in the mesh topology, and each training data item 508 has vertex positions in the same order.

The output of the trained neural network model 506 is a BVH encoding that encodes traversal paths in the BVH for each leaf node. A traversal path is a sequence of traversal directions, starting at the root node (top-most node) and ending with a leaf node. The traversal direction indicates which child the path follows, at any particular non-leaf node. A full traversal path thus specifies a sequence of children to traverse to, starting at the root node and ending at a leaf node. In the example BVH 620 in FIG. 6, a set of traversal paths 626, each encoding a different triangle, is shown. In this example, each traversal path 626 is a sequence of direction indicators, with “0 ” indicating “left child” and “1” indicating “right child. ” The left-most traversal path 626(1) indicates value “00,” as traversal to that node requires traversal in the left direction from the root node and then traversal again in the left direction, from that following node. The next shown traversal path 626(2) indicates value “01,” corresponding to a traversal sequence of left, then right. Similarly, path 626(3) indicates value “10” for right, then left, and path 626(4) indicates value “11”for right, then right.

Using the traversal paths, it is possible to construct a description of a BVH—a BVH encoding 628. Specifically, the BVH encoding 628 includes a sequence of traversal paths. Each traversal path in the encoding 628 is at a particular slot in the encoding 628, and each slot corresponds to a particular triangle of the mesh 602. Thus, a sequence of traversal paths defines, for each triangle of the mesh 602, the location of the corresponding leaf node in a BVH.

It should be noted that the placement of any given triangle within a BVH may change depending on the actual locations of the vertices of that triangle as well as the vertices of the other triangle of the mesh 602. For example, movement or deformation of portions of the mesh may cause some triangles to be in different relative spatial locations. Thus, for any given trained neural network (which again corresponds to a single mesh topology), one or more traversal paths may change based on the vertex position input. However, the identity of the triangle is associated with a particular slot (e.g., position in the order) within the BVH encoding 628 such that even if such traversal paths 626 change, the location of a traversal path 626 for a particular triangle within the BVH encoding 628 remains the same. Put differently, each training data item 508 for a particular mesh training data 504 has traversal paths 626 for the triangles in the same order, even if those traversal paths 626 themselves change.

In summary, any given object or geometric model is associated with a particular trained neural network model 506 and a fixed mesh topology. The fixed mesh topology defines the connectivity of the vertices of the mesh for that geometry model, but does not necessarily define the positions for any of the vertices for that geometry model. The trained neural network model 506 accepts vertex position information for a particular animation state or deformation for the corresponding fixed mesh, and, in response, provides a BVH encoding that describes the traversal path for the triangles of the mesh. Training such a model includes providing data points, each of which includes a set of vertex positions for the vertices of the fixed mesh topology, and a corresponding BVH encoding, generated by a BVH generation algorithm (such as, for example, a surface area heuristic BVH or split BVH technique, or any technically feasible algorithm). The model thus learns how to generate BVHs for a given animation state of a model.

FIG. 7 illustrates operations for performing ray tracing using trained neural network models, according to an example. The operations include a geometry model update operation 702, an inference operation, and a ray tracing operation.

The geometry model update operation 702 includes updating the geometry maintained by an entity such as an application 710. In various examples, the application 710 executes at least partially on the processor 102 and includes, for example, a video game or other rendering app. In some examples, the application 710 is one of the applications 126. In some examples, the application 710 executes on a different device 100 than the training system 502. In an example, a device 100 including the training system 502 trains one or more neural network models 506 at application development time, and a different device 100 including the application 710 uses the one or more neural network models 506 to generate BVHs for rendering. In some alternative examples, a driver 122, performs some or all of the operations described as being performed by the application 710.

Regarding updating the geometry model, the application 710 maintains scene geometry 712, which includes a number of different objects 714, each of which has one or more corresponding meshes. The application 710 performs mesh adjustments in the geometry model update operation 702, meaning that the application 710 makes adjustments to the vertices of one or more items of object geometry 714. In various examples, the application 710 maintains a simulation such as a physics simulation or a simulation based on other factors and the adjustments represent adjustments to the meshes based on the physics simulation.

In operation 704, the application 710 applies the scene geometry as modified by operation 702 to one or more neural network models in one or more inference operations. In some examples, the application 710 causes the adjusted scene geometry to be encoded as a mesh encoding 604 as described elsewhere herein. In some examples, the application 710 provides this mesh encoding 604 to the neural network model 506 in an inference step, and in response, the neural network model 506 outputs a BVH encoding that describes the location in a BVH for the triangles of the adjusted scene geometry.

In operation 706, the application 710 uses the BVH encoding 716 to generate a BVH for the geometry of the scene. Any technique for reconstructing the BVH is possible. In some examples, as described elsewhere herein, the BVH encoding 628 includes a set of traversal paths 626, where each traversal path 626 corresponds to a leaf node of the BVH. Because each such traversal path 626 includes an indication of which direction is to be taken at each node along a path, the combination of the traversal paths 626 implicitly encodes the structure of the BVH. For example, the first element (e.g., 0 or 1) indicates that there is a root node. Presence of specific values in subsequent “slots” of a traversal path 626 corresponds to presence of corresponding nodes in the reconstructed BVH (where a slot indicates a location of an element in a traversal path 626—for example, for a traversal path of “010,” the “1” is in the second slot, and there are “0 's” in the first and third slots). For example, if no traversal path 626 has a particular value for traversal direction that would lead to a node, then the reconstructed BVH 620 does not have that node. By contrast, if at least one traversal path 626 has a value for a traversal direction that necessitates a particular non-leaf node, then the reconstructed BVH 620 includes that node.

In addition to the graph topology, the application 710 also recreates parameters of the non-leaf nodes such as bounding volumes based on the corresponding underlying geometry (for example, based on the minimum and maximum coordinates of the vertices encompassed by that underlying geometry). Once the application 710 has reconstructed the BVH, the application 710 performs ray tracing with that BVH, traversing the BVH for a plurality of rays to render a scene. It should be understood that the application 710 performs such reconstruction for a plurality of neural network models 506, to reconstruct BVHs for the various objects represented in the scene. In examples where the reconstructed BVHs are for bottom-level BVHs, the application 710 constructs the top-level BVH which includes instance nodes that point to such bottom-level BVHs.

FIG. 8A is a flow diagram of a method 800 for training a set of neural network models 506 to provide BVH encodings in response to an input mesh encoding, according to an example. Although described with respect to the system of FIGS. 1-7, those of skill in the art will understand that any system configured to perform the steps of the method 800 in any technically feasible order falls within the scope of the present disclosure.

At step 802, a training system (e.g., an application such as an integrated development) obtains samples for training. In some examples, each sample includes mesh information 510 (which can be encoded as a mesh encoding 604) and BVH information 512 (which can be encoded as a BVH encoding 628). In some examples, the samples include samples corresponding to different geometry models of a scene. More specifically, for each geometry model of a scene, the samples include a plurality of samples, each corresponding to a different animation state. Thus, the samples include enough information to generate one neural network model 506 per geometry model, where each neural network model 506 is capable of predicting a BVH configuration given input vertex information, for a particular mesh or model in a scene. In some examples, for any given object, the mesh information 510 for each training data item 508 has vertex data for the same number of vertices. In other words, for the purpose of training a single neural network model 506, which corresponds to a given mesh, each training data item 508 has vertex information for the same number of vertices, and those vertices have the same connectivity, but the positions of those vertices change across different training data items 508. In addition, the BVH information 512 provided in such training data items 508 can be generated in any technically feasible manner, such as through any of a variety of known techniques for generating BVHs from geometry. At step 804, the training system trains one or more neural network models 506 based on the data obtained at step 802. In an example, the training system trains one neural network model 506 per scene geometry object, so that each such neural network model 506 is capable of providing an output BVH given an animation state for the corresponding scene geometry object. In some examples, the training system, as part of the IDE, accepts or obtains geometry models from a creator of such models such as a human designer or automated process (e.g., in software). Such geometry models specify the manner in which geometry can be moved, deformed, or otherwise adjusted. The IDE samples such geometry models by making a set of such specified adjustments to obtain a number of different modified geometry models, and building a BVH for each such model. Such samples are thus a representative set of possible animations for a geometry model and can thus train a trained neural network model 506 for that purpose. The training in step 804 consists of modifying the weights of the neural network to minimize the error (or “cost”) representing the difference between the input samples and the output generated by the trained neural network. The result of the method 800 is a set of trained neural networks, each of which is capable of generating a BVH given an animation state for a particular model.

FIG. 8B is a flow diagram of a method 850 for obtaining BVH information given a set of input geometry, according to an example. Although described with respect to the system of FIGS. 1-7, those of skill in the art will understand that any system configured to perform the steps of the method 850 in any technically feasible order falls within the scope of the present disclosure.

At step 852, an application 710 obtains a mesh encoding for modeled geometry. The mesh encoding is an encoding of the vertices of the mesh and includes, for example, vertex positions for the mesh. The mesh encoding also identifies the mesh, which allows identification of the trained model from which to obtain the BVH. In some examples, step 852 involves the application 710 modifying some portion of its stored geometry for any technically feasible reason, such as in accordance with an internal physics simulation. Part of this modification involves modifying the geometry of the models for which trained neural network models exist, and such modification, in some situations, includes modification per animation. Modification of a model per animation includes modifying the mesh of the model based on one or more animation parameters, which can include, for example, movement of one or more bones of a skeleton resulting in modification of the positions of the vertices of the mesh. Any technically feasible means for animating or modifying the mesh geometry could be used. The mesh encoding obtained at step 852 includes an encoding of the relevant parameters of the modified vertices, and such encoding can include a combination (e.g., concatenation) of the positions of the vertices of the mesh.

At step 854, the application obtains the obtained mesh encoding to an appropriate trained model. In various examples, the mesh encoding is associated with a mesh identifier, which is, in turn, associated with a particular trained neural network model. Applying the mesh encoding to that trained neural network model in an inference step results in a BVH encoding, as such trained models are trained to produce BVH encodings. In some examples, the BVH encoding is a concatenation of path encodings as described elsewhere herein.

At step 856, the application 710 expands the BVH encoding into a BVH and performs ray tracing. In some examples, the path encodings implicitly encode the BVH tree topology, so expanding the BVH encoding is relatively straightforward. In an example, expanding a BVH encoding includes generating a BVH tree having, as its set of nodes, the union of nodes indicated as being traversed in all path traversals for the BVH encoding. For example, if an element of a path traversal indicates that a particular direction is taken at a particular non-leaf node, then a non-leaf node for that particular direction must exist in the expanded BVH. In addition to recreating the topology, the application 710 also recreates other parameters of the non-leaf nodes. For example, the application 710 generates the bounding volumes of the non-leaf nodes by creating a bounding volume having extents in each of three dimensions corresponding to the minimum and maximum vertex coordinates for all leaf nodes that are descendants of that bounding volume.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the accelerated processing device 116, the scheduler 136, the compute units 132, the SIMD units 138, the ray tracing pipeline 300, including the ray generation shader 302, acceleration structure traversal stage 304, any hit shader 306, hit or miss unit 308, closest hit shader 310, miss shader 312, or BVH builder 502 may be implemented as a general purpose computer, a processor, a processor core, or in digital circuitry or analog circuitry, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
encoding a mesh to form a mesh encoding;
applying the mesh to a trained model to obtain a bounding volume hierarchy (“BVH”) encoding; and
expanding the BVH encoding to obtain a BVH for the mesh.

2. The method of claim 1, wherein encoding the mesh comprises generating a sequence including, for a plurality of vertices of the mesh, positions of the vertices in order.

3. The method of claim 1, wherein the mesh corresponds to an object of a scene and the trained model also corresponds to the object.

4. The method of claim 1, wherein the BVH encoding includes a set of path encodings, wherein each path encoding describes a path from a root node to a leaf node of the BVH.

5. The method of claim 4, wherein expanding the BVH encoding includes generating the BVH to have a set of non-leaf nodes defined by the set of path encodings.

6. The method of claim 5, wherein the set of non-leaf nodes includes a union of non-leaf nodes implicitly indicated in the set of path encodings.

7. The method of claim 1, further comprising applying a plurality of additional mesh encodings to a plurality of corresponding trained models to obtain a plurality of BVH encodings.

8. The method of claim 7, wherein each additional mesh encoding corresponds to a different object of a scene.

9. The method of claim 1, further comprising training the trained model by providing mesh training data comprising a plurality of training data items, wherein each training data item includes a mesh encoding and a corresponding BVH encoding, and wherein each training data item corresponds to a different animation state of a single object.

10. A system comprising:
a memory configured to store a mesh; and
a processor configured to perform operations comprising:
encoding the mesh to form a mesh encoding;
applying the mesh to a trained model to obtain a bounding volume hierarchy (“BVH”) encoding; and
expanding the BVH encoding to obtain a BVH for the mesh.

11. The system of claim 10, wherein encoding the mesh comprises generating a sequence including, for a plurality of vertices of the mesh, positions of the vertices in order.

12. The system of claim 10, wherein the mesh corresponds to an object of a scene and the trained model also corresponds to the object.

13. The system of claim 10, wherein the BVH encoding includes a set of path encodings, wherein each path encoding describes a path from a root node to a leaf node of the BVH.

14. The system of claim 13, wherein expanding the BVH encoding includes generating the BVH to have a set of non-leaf nodes defined by the set of path encodings.

15. The system of claim 14, wherein the set of non-leaf nodes includes a union of non-leaf nodes implicitly indicated in the set of path encodings.

16. The system of claim 10, wherein the operations further comprise applying a plurality of additional mesh encodings to a plurality of corresponding trained models to obtain a plurality of BVH encodings.

17. The system of claim 16, wherein each additional mesh encoding corresponds to a different object of a scene.

18. The system of claim 10, wherein the operations further comprise training the trained model by providing mesh training data comprising a plurality of training data items, wherein each training data item includes a mesh encoding and a corresponding BVH encoding, and wherein each training data item corresponds to a different animation state of a single object.

19. A non-transitory computer-readable medium storing instructions that, when executed by a processor, cause the processor to perform operations comprising:
encoding a mesh to form a mesh encoding;
applying the mesh to a trained model to obtain a bounding volume hierarchy (“BVH”) encoding; and
expanding the BVH encoding to obtain a BVH for the mesh.

20. The non-transitory computer-readable medium of claim 19, wherein encoding the mesh comprises generating a sequence including, for a plurality of vertices of the mesh, positions of the vertices in order.
